(19) United States
(12) Patent Application Publication
(10) Pub. No.: US 2020/0358293 A1
(43) Pub. Date: Nov. 12, 2020

(54) POWER SUPPLY METHOD

(71) Applicant: GETAC TECHNOLOGY CORPORATION, Hsinchu county (TW)

(72) Inventors: CHENG-HAH TSAI, Taipei City (TW); YING-WEI LI, Taipei City (TW)

(21) Appl. No.: 16/404,624

(22) Filed: May 6, 2019

(51) Int. Cl. H02J 7/00; H01R 24/60; H01R 13/641

(52) U.S. Cl. CPC H02J 7/0004; H02J 7/0011; H02J 7/0021; H02J 2007/0049; H01R 24/60; H01R 13/641; H02J 7/0047

(57) ABSTRACT

A connector is connected between a power supply device and a power receiving device. A power supply method includes the following steps. After it is confirmed that the connector, the power supply device and the power receiving device are successfully connected, a microprocessor of the power receiving device is activated to determine whether at least one battery of the power receiving device needs to be charged, and when it is determined that the at least one battery needs to be charged, the microprocessor determines a rated voltage of the battery and outputs a corresponding instruction to the connector. Next, the connector enables the power supply device to provide a corresponding output voltage according to the instruction to charge the battery, and the connector causes the power supply device to provide a larger output voltage as the rated voltage of the battery increases.

### BACKGROUND OF THE INVENTION

### Field of the Invention

The present invention relates to a power supply method and, more particularly, to a power supply method enabling a power supply device to provide an appropriate output voltage according to a rated voltage of a battery in a power receiving device.

### Description of the Prior Art

USB Type-C can support the new-generation USB power delivery (PD) specification which allows a power supply device to provide output voltages of different levels, e.g., 5 V, 9 V, 15 V or 20 V. Thus, current power supply devices, such as AC adapters, have gradually switched to use USB Type-C connectors for power transmission. Meanwhile, some manufacturers compile vendor defined messages (VDM) in power receiving devices for USB Type-C connectors to perform identification. Thus, once a power receiving device is connected through a USB Type-C connector to a power supply device, the USB Type-C connector can enable, according to the VDM of the power receiving device, the power supply device to provide a fixed output voltage as a supply voltage required for operating the power receiving device. However, apart from a power supply device, a power source of a power receiving device can also be a battery thereof. Furthermore, after the power supply device provides an output voltage, e.g., 20 V, according to the VDM, the power receiving device again converts the 20-V voltage to a rated voltage of the battery thereof, e.g., a 12.6-V voltage to charge the battery thereof. However, due to a voltage conversion difference, the efficiency of converting 20 V to 12.6 V is definitely lower than the efficiency of converting 15 V to 12.6 V, such that the above prior art cannot provide benefits of cooling and power saving.

### SUMMARY OF THE INVENTION

In view of the above, it is an object of the present invention to provide a power supply method enabling a power supply device to provide an appropriate output voltage according to a rated voltage of a battery in a power receiving device. To achieve the above object, a power supply method, implemented in a connector, a power supply device and a power receiving device, is provided according to an embodiment of the present invention, wherein the connector is connected between the power supply device and the power receiving device. The power supply method includes the following steps. After it is confirmed that the connector, the power supply device and the power receiving device are successfully connected, a microprocessor of the power receiving device is activated to determine whether at least one battery of the power receiving device needs to be charged, and when it is determined that the at least one battery needs to be charged, the microprocessor determines a rated voltage of the battery and outputs a corresponding instruction to the connector. Next, according to the instruction, the connector enables the power supply device to provide a corresponding output voltage to charge the battery, and the connector causes the power supply device to provide a larger output voltage as the rated voltage of the battery increases.

To further understand the features and technical contents of the present invention, details of the present invention are given with the accompanying drawings in the description below. However, the description and the accompanying drawings are merely for explaining the present invention and are not to be construed as limitations to the claimed scope of the present invention.

### BRIEF DESCRIPTION OF THE DRAWINGS

FIG. 1 is a schematic diagram of a connector, a power supply device and a power receiving device provided according to an embodiment of the present invention;

FIG. 2 is a flowchart of a power supply method provided according to an embodiment of the present invention; and

FIG. 3 is a flowchart of a power supply method provided according to another embodiment of the present invention.

### DETAILED DESCRIPTION OF THE EMBODIMENTS

In the description below, various embodiments of the present invention are given to describe the present invention in detail with the accompanying drawings. However, the concepts of the present invention can be embodied by numerous different forms and are not to be construed as being limited to the exemplary embodiments given in the description. Furthermore, the same reference numerals in the drawings can represent similar elements.

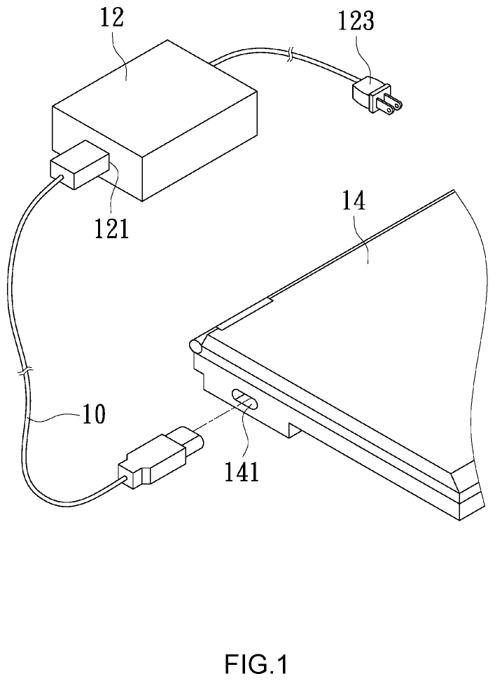

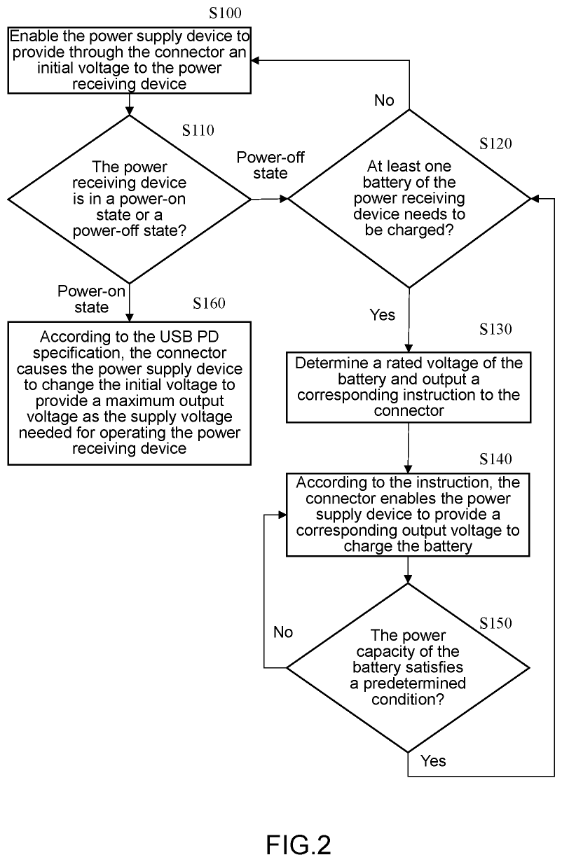

First refer to both FIG. 1 and FIG. 2. FIG. 1 shows a schematic diagram of a connector, a power supply device and a power receiving device provided according to an embodiment of the present invention. FIG. 2 shows a flowchart of a power supply method provided according to an embodiment of the present invention. It should be noted that, the power supply method in FIG. 2 can be implemented in a connector 10, a power supply device 12 and a power receiving device 14 in FIG. 1. However, the present invention does not limit the specific implementation forms of the connector 10, the power supply device 12 and the power receiving device 14 in FIG. 1. As previously stated, the USB PD specification allows the power supply device 12 to provide output voltages of different levels. Thus, in the embodiment in FIG. 1, the connector 10 can be, for example, a USB Type-C connector supporting the USB PD specification, and the power supply device 12 and the power receiving device 14 are respectively, for example, an AC adapter and a laptop computer similarly supporting the USB PD specification; however, the present invention is not limited to the above examples.

Furthermore, the power supply device 12 may be provided with a male/female connector 121 connected to the connector 10, and a power plug 123 connected to commercial power (not shown). Moreover, for better illustrations, an example of assuming that the power supply device 12 is connected through the power plug 123 to commercial power is given in this embodiment. Similarly, the power receiving device 14 can primarily include a microprocessor and at least one battery (neither shown), and the power receiving device 14 may be provided with a female connector 141 connected to the connector 10. Thus, in this embodiment, the connector 10 is connected between the power supply device 12 and the power receiving device 14, and after it is confirmed that the connector 10, the power supply device 12 and the power receiving device 14 are all successfully connected, the connector 10 can transmit an output voltage (not shown) provided by the power supply device 12 to the power receiving device 14 according to the USB PD specification.

As shown in FIG. 2, in step S100, after it is confirmed that the connector 10, the power supply device 12 and the power receiving device 14 are all successfully connected, the power supply method of this embodiment enables the power supply device 12 to provide through the connector 10 an initial voltage to the power receiving device 14; after the power receiving device 14 receives the initial voltage, the power receiving device 14 then converts the initial voltage to an operating voltage needed for operating the microprocessor thereof, and provides the operating voltage to the microprocessor to activate the microprocessor to perform step S120, i.e., determining whether at least one battery of the power receiving device 14 needs to be charged. It should be noted that, the present invention does not limit specific implementation details for confirming whether the connector 10, the power supply device 12 and the power receiving device 14 are all successfully connected, nor does the present invention limit specific implementation details of how the microprocessor determines whether the at least one battery needs to be charged. A person skilled in the art can carry out associated designs according to actual requirements or applications. Moreover, in this embodiment, the initial voltage may be, e.g., 5 V, and the operating voltage may be, e.g., 3.3 V; however, the present invention is not limited to these examples.

Next, if it is determined that the at least one battery does not need to be charged, the power supply method of this embodiment returns to perform step S100. However, if it is determined that the at least one battery needs to be charged, the power supply method of this embodiment performs step S130, step S140 and step S150. In step S130, the microprocessor determines a rated voltage of the battery that needs to be charged, and outputs a corresponding instruction to the connector 10. Then, in step S140, according to the instruction, the connector 10 enables the power supply device 12 to provide a corresponding output voltage to charge the battery. It is understandable that, the rated voltage of the battery that needs to be charged refers to an ideal charging voltage required during charging of the battery, and the connector 10 should enable the power supply device 12 to provide a larger output voltage as the rated voltage of the battery that needs to be charged increases. Furthermore, in another embodiment, the microprocessor can also swap the sequences of step S130 and step S120, and slightly correspondingly modify the battery objects in the two steps. That is to say, the microprocessor can determine whether at least one battery of the power receiving device 14 needs to be charged only after it determines the rated voltage of the at least one battery, and output a corresponding instruction to the connector 10 after determining that the battery needs to be charged. In brief, the above modification does not affect the implementation of the present invention.

For example, given that the connector 10 supports the USB PD 3.0 specification, the connector 10 allows the power supply device 12 to provide a 5-V, 9-V, 15-V or 20-V output voltage. If the rated voltage of the battery that needs to be charged is 8.4 V, because the efficiency of converting 9 V to 8.4 V is definitely better than the efficiency of converting 15 V or 20 V to 8.4 V as a result of a voltage conversion difference, the connector 10 should enable the power supply device 12 to correspondingly provide a 9-V output voltage. Similarly, assuming that the rated voltage of the battery that needs to be charged is 12.6 V, because the efficiency of converting 15 V to 12.6 V is also definitely better than the efficiency of converting 20 V to 12.6 V as a result of a voltage conversion difference, the connector 10 should enable the power supply device 12 to correspondingly provide a 15-V output voltage. That is to say, after the connector 10 receives the instruction and learns the ideal charging voltage needed for charging the battery, the connector 10 should enable the power supply device 12 to selectively provide an output voltage closest to the level of the ideal charging voltage, so as to reduce the voltage drop of a charging voltage converted from the output voltage, which is equivalently enhancing the efficiency of voltage conversion so as to provide benefits of cooling and power saving.

A battery is usually considered fully charged when the power capacity reaches above 80%; however, the present invention is not limited thereto. Thus, in step S150, the microprocessor can again determine whether the power capacity of the battery charged satisfies a predetermined condition, e.g., a power capacity of above 80%. If not, the process returns to step S140 to continue charging the battery; if so, the process returns to step S120 to determine whether there is another battery that needs to be charged. In another embodiment, if it is determined that the power capacity of the battery charged satisfies the predetermined condition, the microprocessor can also change the process of the power supply method to return to step S100 from step S150, which does not affect the implementation of the present invention. Furthermore, as previously stated, in addition to being used for directly charging the at least one battery, the output voltage provided by the power supply device 12 can also be used as a supply voltage needed for operating the power receiving device 14. Thus, the power supply method can further include step S110 after step S100 in FIG. 2. In step S110, the power supply method of this embodiment activates the microprocessor to determine whether the power receiving device 14 is in a power-on state or a power-off state.

Similarly, the present invention does not limit the specific implementation forms of how the microprocessor determines whether the power receiving device 14 is in a power-off state or a power-on state, and a person skilled in the art can carry out associated designs according actual requirements or applications. It is understandable that, if the power receiving device 14 is in a power-off state, the power supply method of this embodiment is performed in continuation from step S130; however, if the power receiving device 14 is in a power-on state, the power supply method of this embodiment then performs step S160. In step S160, the connector 10 causes the power supply device 12 to change the initial voltage according to the USB PD specification, so as to provide a maximum output voltage as the supply voltage needed for operating the power receiving device 14. For example, given that the connector 10 similarly supports the USB PD 3.0 specification, the connector 10 allows the power supply device 12 to provide an output voltage of a maximum of 20 V. Hence, in this embodiment, the maximum output voltage can then be, for example, 20 V, and the 20-V maximum output voltage can also be used for charging the at least one battery of the power receiving device 14. Associated details are given in the foregoing description, and are not repeated herein.

Furthermore, to prolong the durability of a battery or to meet the trend of being light and slim, a power receiving device can further include a battery consisting of different numbers of strings. For example, the power receiving device 14 in FIG. 1 can include a bridge battery consisting of two strings, a backup battery consisting of four strings, and a main battery consisting of three strings. It should be noted that, the rated voltage of each battery is determined by the number of strings used for the battery, and the rated voltage relatively increases as the number of strings gets larger. For example, the rated voltage of the foregoing bridge battery can be 8.4 V, and the rated voltages of the main battery and the backup battery are respectively 12.6 V and 16.8 V; however, the present invention is not limited to the examples. Furthermore, the foregoing bridge battery refers to a built-in battery that cannot be observed or removed by a user, and particularly, the bridge battery necessarily serves as the only substitution for the main battery and the backup battery after the user removes the main battery and the backup battery. Therefore, the bridge battery needs to have the highest charging priority, so as to ensure that the main battery and the backup battery can be hot-plugged in a situation where the system is not shut down.

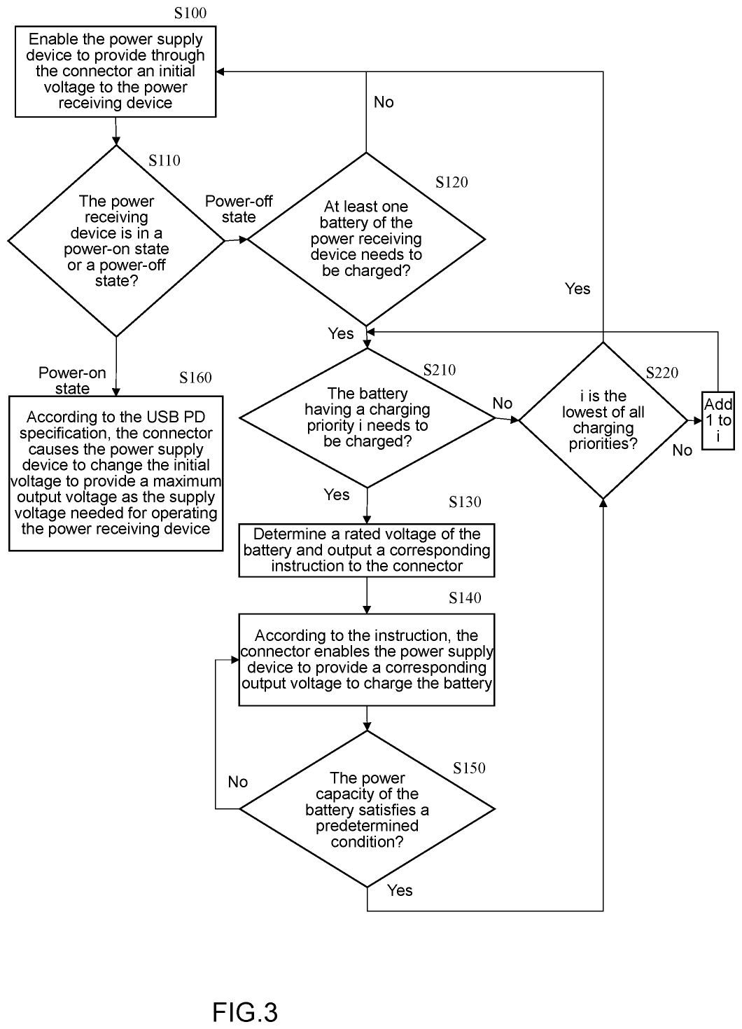

Further, the backup battery is, for example, a reserve battery, and primarily has two functions—one is serving as a backup of power supply when the main battery is depleted or removed, and the other is purely for prolonging the durability of the battery. Hence, although the charging priority of the backup battery is lower than the charging priority of the bridge battery, it is however higher than the charging priority of the main battery. Finally, the main battery serves as a core of power supply; however, it does not prolong the durability of the battery nor does it serve as power for hot-plugging the backup battery, and thus the charging priority of the main battery is the lowest. That is to say, in a situation where the power receiving device 14 includes more than two batteries, these batteries can have respective different rated voltages and charging priorities. Refer to FIG. 3 showing a flowchart of a power supply method provided according to another embodiment of the present invention. The steps in the process in FIG. 3 same as those in FIG. 2 are denoted by the same numerals, and thus associated details are not repeated herein. Furthermore, FIG. 3 can similarly be implemented in the connector 10, the power supply device 12 and the power receiving device 14 in FIG. 1; however, the present invention is not limited thereto.

As shown in FIG. 3, in addition to step S130 to step S150, after determining that the at least one battery needs to be charged, the power supply method of this embodiment can further include step S210, step S220 and step S230. In step S210, the microprocessor again determines whether the battery having a charging priority i needs to be charged. For better illustrations, it is assumed in this embodiment that the charging priorities of the foregoing batteries are all represented by integers, and the charging priority is higher as the value gets smaller. For example, the charging priority of the bridge battery is 0, and the charging priorities of the backup battery and the main battery are respectively 1 and 2; however, the present invention is not limited to the above examples. Thus, in this embodiment, i is sequentially 0, 1 and 2. That is to say, when step S210 is performed for the first time, the microprocessor first determines whether the bridge battery having a charging priority 0 needs to be charged. If not, the process continues to step S220; if so, the process continues to step S130 to determine the rated voltage (e.g., 8.4 V) of the bridge battery and to output a corresponding instruction to the connector 10. Then, in step S140, according to the instruction, the connector 10 enables the power supply device 12 to provide a corresponding output voltage, e.g., 9 V, to charge the bridge battery.

Then, in step S150, the microprocessor can again determine whether the power capacity of the charged bridge battery satisfies a predetermined condition, e.g., a power capacity of above 80%. If not, the process returns to step S140 to continue charging the bridge battery; if so, the process continues to step S220. In step S220, the microprocessor determines whether the charging priority of the bridge battery is the lowest of all charging priorities, which is equivalently determining whether i is the lowest of all charging priorities. If so, the process returns to step S100; if not, the process continues to step S230. It should be noted that, because the charging priority of the bridge battery is not the lowest of all charging priorities, the determination result at this point in time leads to performing step S230. Furthermore, as previously stated, it is assumed in this embodiment that all charging priorities are represented by integers, and the charging priority gets higher as the value gets smaller. Thus, in step S230 of this embodiment, the microprocessor adds 1 to i, and the process returns to step S210 after i is added by 1.

Alternatively speaking, in another embodiment, it can also be assumed that the charging priority gets higher as the value i gets larger. Thus, in step S230 of another embodiment, the microprocessor subtracts 1 from i, and the process returns to step S210. In brief, the present invention does not limit specific implementation form of step S230, and a person skilled in the art can carry out associated designs according to actual requirements or applications. Similarly, when step S210 is performed for the second time, the microprocessor determines whether the backup battery having a charging priority 1 needs to be charged. If so, the process continues to step S130 to determine the rated voltage (e.g., 16.8 V) of the backup battery and to output a corresponding instruction to the connector 10. Then, in step S140, according to the instruction, the connector 10 enables the power supply device 12 to provide a corresponding output voltage, e.g., a 20-V voltage, to charge the backup battery. When the power capacity of the backup battery satisfies a predetermined condition, and the microprocessor determines that the charging priority of the backup battery is not the lowest of all charging priorities, the microprocessor adds 1 to i, and the process returns to step S210 after i is added by 1.

Then, when step S210 is performed for the third time, the microprocessor determines whether the main battery having a charging priority 2 needs to be charged. If not, the process continues to step S220, and the determination result at this point in time leads to returning to step S100 because the charging priority of the main battery is indeed the lowest of all charging priorities. That is to say, in the steps in FIG. 3 after determining that the at least one battery needs to be charged, the microprocessor sequentially determines according to the sequences of the charging priorities of these batteries whether one of these batteries needs to be charged, and when it is determined that one battery needs to be charged, the rated voltage of the battery is determined and a corresponding instruction is outputted to the connector 10. According to the instruction, the connector 10 enables the power supply device 12 to provide a corresponding output voltage to charge the battery until the power capacity of the battery satisfies a predetermined condition. Then, the process returns to the step of sequentially determining whether one of these batteries needs to be charged according to sequences of the charging priorities of these batteries. It should be noted that, the process at this point in time returns from step S220 to step S100, which means that none of the batteries in the power receiving device 14 needs to be charged. Thus, the power supply method at this point in time continues performing the loop of step S100, step S110 and step S120, and the power supply method of this embodiment then enters step S160 from step S110 when the power receiving device 14 is in a power-on state. Associated details are described above, and thus are not repeated herein.

In conclusion, different from the prior art in which a power supply device provides a fixed output voltage according to a VDM of a power receiving device, the power supply method provided by the embodiments of the present invention enables a power supply device to provide an appropriate output voltage according to a rated voltage of a battery in a power receiving device. More particularly, when a power receiving device is in a power-off state and a connector receives an instruction and learns the rated voltage of a battery that needs to be charged, the connector can enable the power supply device to selectively provide an output voltage closest to the rated voltage, thereby reducing a voltage drop of the rated voltage converted from the output voltage, which is equivalently enhancing the efficiency of voltage conversion and providing benefits of cooling and power saving. In addition, regardless of whether a power receiving device is in a power-off state or a power-on state, or whether a power receiving device includes batteries having different charging priorities, a connector can enable a power supply device to selectively provide an appropriate output voltage by using the power supply method of the present invention.

The above disclosure describes only embodiments of the present invention, and is not to be construed as limitations to the claimed scope of the present invention.

What is claimed is:

1. A power supply method, implemented in a connector, a power supply device and a power receiving device, the connector connected between the power supply device and the power receiving device, the power supply method comprising:
after confirming that the connector, the power supply device and the power receiving device are successfully connected, activating a microprocessor of the power receiving device to determine whether at least one battery of the power receiving device needs to be charged; and when it is determined that the at least one battery needs to be charged, the microprocessor determining a rated voltage of the battery and outputting a corresponding instruction to the connector; and
the connector enabling, according to the instruction, the power supply device to provide a corresponding output voltage to charge the battery, and the connector causing the power supply device to provide the output voltage having a larger value as the rated voltage of the battery increases.

2. The power supply method according to claim 1, wherein the connector is a USB Type-C connector supporting a USB power delivery (PD) specification, and the power supply device and the power receiving device are respectively an AC adapter and an electronic device similarly supporting the USB PD specification.

3. The power supply method according to claim 2, after confirming that the connector, the power supply device and the power receiving device are successfully connected, the power supply method further comprising:
enabling the power supply device to provide through the connector an initial voltage to the power receiving device, and activating the microprocessor to determine whether the power receiving device is in a power-on state or a power-off state;
if the power receiving device is in the power-off state, the power supply method performing in continuation the step of activating the microprocessor to determine whether the at least one battery of the power receiving device needs to be charged; and
if the power receiving device is in the power-on state, the connector causing the power supply device to change the initial voltage according to the USB PD specification to provide a maximum output voltage as a supply voltage needed for operating the power receiving device, wherein the maximum output voltage is also used for charging the at least one battery.

4. The power supply method according to claim 3, wherein the at least one battery is more than two batteries, and the batteries have respective different rated voltages and charging priorities.

5. The power supply method according to claim 4, wherein in the steps after the microprocessor determined that the at least one battery needs to be charged, comprising:
sequentially determining according to sequences of the charging priorities whether one of these batteries needs to be charged, and when it is determined that the battery needs to be charged, determining the rated voltage of the battery and outputting the corresponding instruction to the connector; and
the connector causing, according to the instruction, the power supply device to provide the corresponding output voltage to charge the battery, and when a power capacity of the battery satisfies a predetermined condition, returning to the step of sequentially determining according to sequences of the charging priorities whether one of these batteries needs to be charged.

6. The power supply method according to claim 5, wherein when it is determined that the battery does not need to be charged or the power capacity of the battery satisfies the predetermined condition, the power supply method further comprising:
determining whether the charging priority of the battery is the lowest of the charging priorities, and if so, returning to the step of enabling the power supply device to provide through the connector the initial voltage to the power receiving device.

7. The power supply method according to claim 1, wherein the rated voltage of the battery is determined by a number of strings used in the battery, and the rated voltage increases as the number of strings gets larger.
